(19) United States
(12) Patent Application Publication
(10) Pub. No.: US 2021/0125064 A1
(43) Pub. Date: Apr. 29, 2021

(54) METHOD AND APPARATUS FOR TRAINING NEURAL NETWORK

(71) Applicant: Preferred Networks, Inc., Tokyo (JP)

(72) Inventors: Ruizhe ZHAO, Tokyo (JP); Brian VOGEL, Tokyo (JP); Tanvir AHMED, Tokyo (JP)

(21) Appl. No.: 17/073,517

(22) Filed: Oct. 19, 2020

Related U.S. Application Data
(60) Provisional application No. 62/925,321, filed on Oct. 24, 2019.

(51) Int. Cl. G06N 3/08; G06N 3/04

(52) U.S. Cl. CPC G06N 3/08; G06N 3/04

(57) ABSTRACT

Techniques for training neural networks in accordance with an adaptive loss scaling scheme are disclosed. One aspect of the present disclosure relates to a method of training a neural network including a plurality of layers, including determining, by one or more processors, layer-wise loss scale factors for the respective layers and updating, by the one or more processors, parameters for the layers in accordance with error gradients for the layers, wherein the error gradients are scaled with the corresponding layer-wise loss scale factors.

### CROSS-REFERENCE TO RELATED APPLICATIONS

This application claims the benefit of U.S. Provisional Patent Application No. 62/925,321, filed Oct. 24, 2019, which is incorporated by reference herein in its entirety.

### BACKGROUND

### 1. Technical Field

The disclosure herein relates to a training method and a training apparatus.

### 2. Description of the Related Art

Training deep neural networks (DNNs) is well-known to be time and energy consuming. One solution to improve training efficiency is to use numerical representations that are more hardware-friendly. This is because the IEEE 754 32-bit single-precision floating point format (FP32) is more widely used for training DNNs than the more precise double-precision floating point format (FP64), which is commonly used in other areas of high-performance computing. In an effort to further improve hardware efficiency, there has been increasing interest in using data types for training with even lower precision than the FP32. Among them, the IEEE half-precision floating point format (FP16) is already well supported by modern GPU vendors. Using the FP16 for training DNNs can reduce memory footprints by half compared to the FP32 and significantly improve the runtime performance and power efficiency. Nevertheless, numerical issues such as overflow, underflow and rounding errors may frequently occur while training the DNNs in the FP16.

### SUMMARY

The present disclosure relates to training neural networks in accordance with an adaptive loss scaling scheme.

One aspect of the present disclosure relates to a method of training a neural network including a plurality of layers, comprising: determining, by one or more processors, layer-wise loss scale factors for the respective layers; and updating, by the one or more processors, parameters for the layers in accordance with error gradients for the layers, wherein the error gradients are scaled with the corresponding layer-wise loss scale factors.

### BRIEF DESCRIPTION OF THE DRAWINGS

Other objects and further features of the present invention will be apparent from the following detailed description when read in conjunction with the accompanying drawings, in which:

FIG. 1 is a schematic drawing for illustrating a training apparatus according to one embodiment of the present disclosure;

FIG. 2A to 2C are schematic drawings for illustrating exemplary FP32 and FP16 formats;

FIG. 3 is a schematic drawing for illustrating one exemplary distribution of the gradients computed during the backward pass in FP16 format;

FIG. 4 is a schematic drawing for illustrating conventional exemplary forward and backward passes in a training operation;

FIG. 5 is a schematic drawing for illustrating exemplary forward and backward passes in a training operation based on an adaptive loss scaling scheme according to one embodiment of the present disclosure;

FIG. 6 is a block diagram for illustrating one exemplary functional arrangement of a training apparatus according to one embodiment of the present disclosure;

FIG. 7 is a flowchart for illustrating one exemplary training operation according to one embodiment of the present disclosure; and

FIG. 8 is a block diagram for illustrating one hardware arrangement of a training apparatus according to one embodiment of the present disclosure.

### DESCRIPTION OF THE PREFERRED EMBODIMENTS

Embodiments of the present disclosure are described in detail below with reference to the drawings. The same or like reference numerals may be attached to components having substantially the same functionalities and/or components throughout the specification and the drawings, and descriptions thereof may not be repeated.

[Overview]

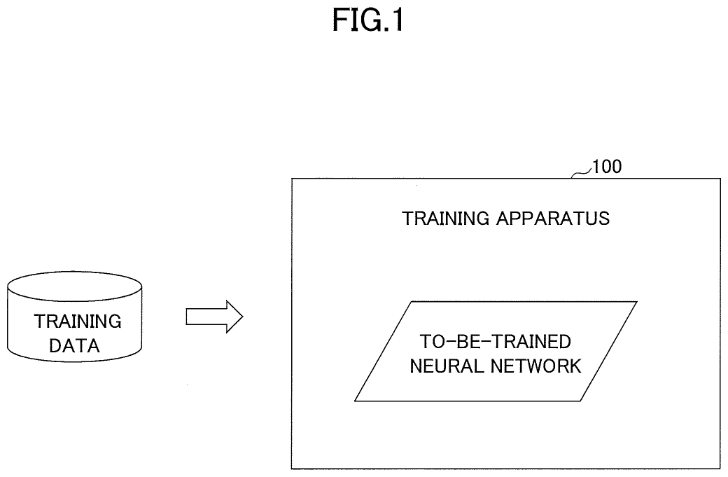

In embodiments below of the present disclosure, a training apparatus 100 for training a to-be-trained neural network is disclosed. As illustrated in FIG. 1, the training apparatus 100 uses training data to update parameters for the to-be-trained neural network.

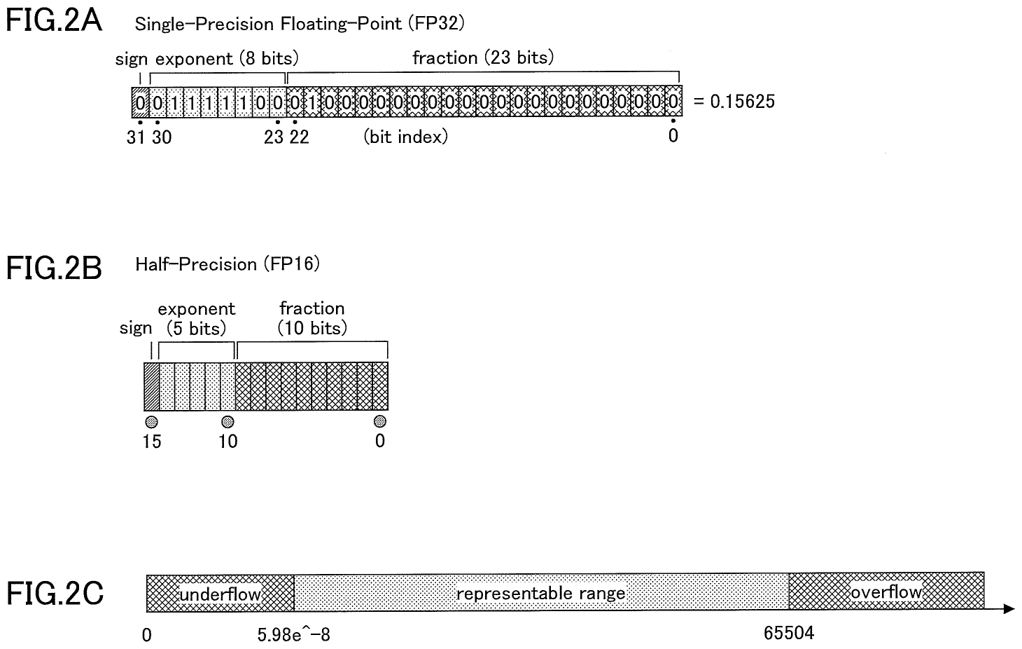

Particularly, the training apparatus 100 is preferably available for IEEE half-precision floating point format (FP16). Conventionally, IEEE 32-bit single-precision floating point format (FP32) as illustrated in FIG. 2A is widely used for training neural networks such as DNNs (Deep Neural Networks). In order to further improve hardware efficiency, there has been increasing interest in using data types with lower precision than the FP 32. The FP16 as illustrated in FIG. 2B is already well supported by modern GPU vendors. Using the FP16 for training DNNs can reduce the memory footprints by half compared to the FP32 and significantly improve the runtime performance and power efficiency.

Nevertheless, numerical issues such as overflow, underflow and rounding errors frequently occur in training with the FP16. For example, as illustrated in FIG. 2C, very small values in an underflow range smaller than 5.98e⁻⁸ may become 0. Also, if a learning rate is multiplied with a small gradient, the product may become 0, which may cause the gradient to vanish. On the other hand, very large values in an overflow range larger than 65504 may become NaN (Not a Number), and as a result, training normally cannot continue. Even in the usable or representable range between the underflow range and the overflow range, rounding errors may occur due to coarse resolution. Also, swamping problem may arise, and addition of large values to small values may truncate the smaller ones.

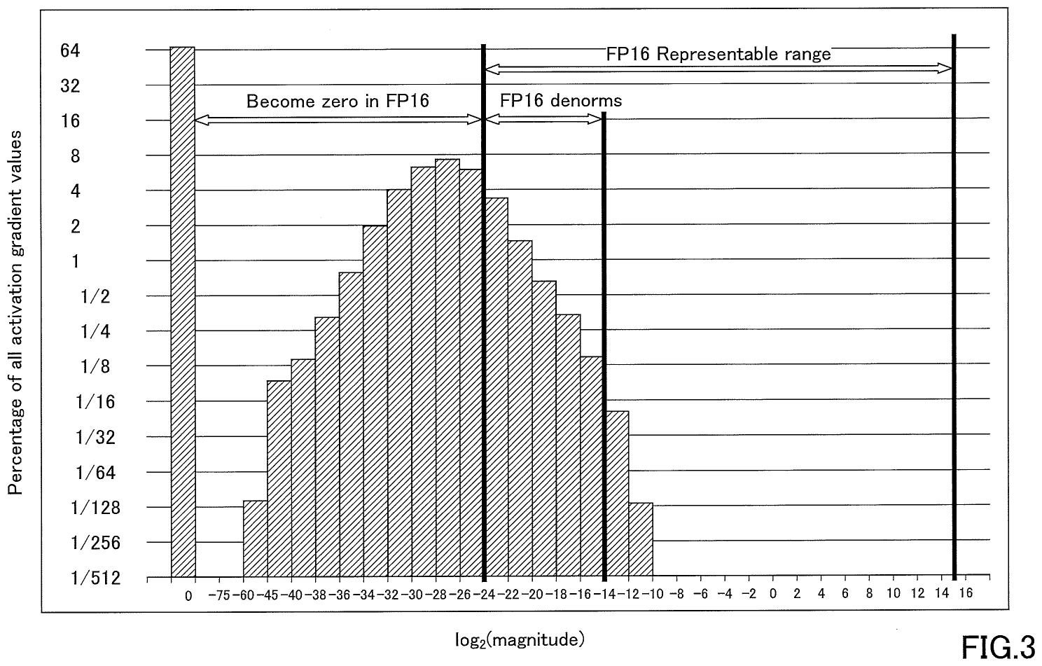

As one solution to address the above-stated disadvantages of the FP16, the loss scaling technique is known. The loss scaling technique addresses the above-stated range limitation in the FP16 by introducing a hyperparameter a to scale loss values before the start of a backward pass for updating parameters for neural networks, so that the computed or scaled gradients can be properly represented in the FP16 without causing significant underflow. For example, the loss scaling technique serves to shift the distribution of activation gradient values as illustrated in FIG. 3 into the FP16 representable range. As a result, the underflow range and the overflow range can be shifted into the FP16 representable range.

For an appropriate choice of a, the loss scaling technique can achieve results that are competitive with regular FP32 based training. However, there is no single value of a that will work well in arbitrary models, and so it often needs to be tuned per model. Its value must be chosen large enough to prevent the underflow issue from affecting training accuracy. On the other hand, if a is chosen too large, it could amplify the rounding errors caused by swamping or even result in the overflow. Furthermore, the data distribution of gradients can vary both between layers and between iterations, which implies that a single scale factor is insufficient.

The present disclosure improves the existing loss scaling technique. Specifically, the training apparatus 100 according to embodiments of the present disclosure as stated below uses an adaptive loss scaling methodology to update parameters for neural networks.

[Training without Loss Scaling]

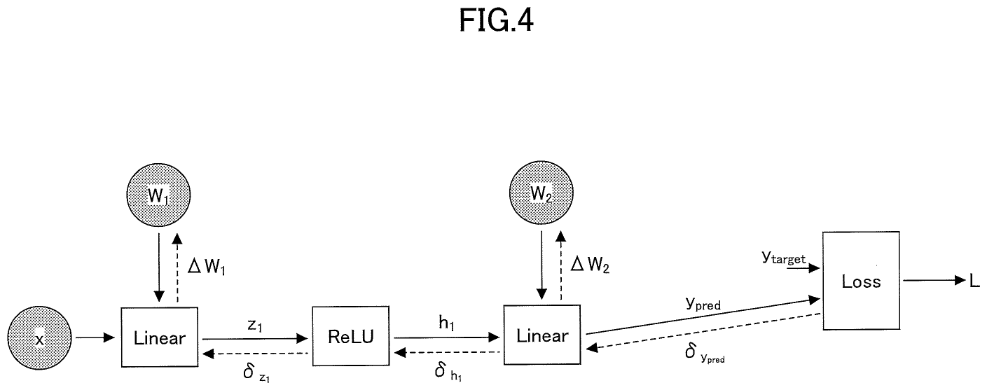

First, an exemplary training operation without the loss scaling is described with reference to FIG. 4. FIG. 4 is a schematic drawing for illustrating an exemplary training operation for a neural network.

In the illustrated example, the neural network is composed of two linear layers, a single non-linear activation function and an output loss function. Without loss of generality, a ReLU layer may be used for the activation function, and squared-error loss function may be used for the output loss function. Also, the linear layers include weight layers W₁ and W₂, respectively. For ease in description, it is assumed that there is no bias term. However, the present disclosure is not limited to the specific type of neural network and can be applied to any other type of neural network.

The neural network is trained with a set of N training instances (xᵢ, yᵢ) for i∈1, . . . , N in a supervised training manner. Here, xᵢ represents an input feature vector in R^{m}, and yᵢ represents the corresponding target value as another vector in Rⁿ. For example, in an image classification task, xᵢ could represent pixel intensities of an image which are then flattened into a vector representation with values in the range [0, 1], and yᵢ could represent the corresponding predicted class, also with values in the range [0, 1]. For example, if there are n object classes, the values in yᵢ may represent the confidence that the corresponding classes are present or not in the input image. To simplify the notation, the subscript i may be dropped.

Upon receiving an input vector x, the neural network outputs a prediction value y_{pred} in the forward pass. In the forward pass in the illustrated architecture, the input vector x is multiplied with the weight W₁ at the first linear layer, and the result zᵢ is generated and then passed to the activation function ReLU. The incoming zᵢ is transformed into h₁ at the ReLU function layer and then passed to the second linear layer. The incoming h₁ is multiplied with the weight W₂ at the second linear layer, and the result y_{pred} is generated. The generated prediction value y_{pred} is compared to the corresponding ground truth output y_{target} by a loss function (sometimes also called a cost function), and the output loss value is represented by a scalar value L. As one example, the squared-error function below may be used as the loss function,

$$Loss ( {y}_{pred} , {y}_{target} ) = \frac{1}{2} {‖ {y}_{pred} - {y}_{target} ‖}^{2}$$

Formally, some computations below are performed in the forward pass,

z₁=W₁x

h₁=ReLU(z₁)

y_{pred}=W₂h₁ and

L=Loss(y_{pred},y_{target}).

where the scalar value L may represent the score of how well the prediction value y_{pred} matches the ground truth output y_{target}.

On the other hand, in the backward pass, upon receiving the loss value L, an error gradient δ_{ypred} a for the prediction value y_{pred} is calculated as follows,

$${δ}_{{y}_{pred}} = \frac{\partial L}{\partial {y}_{pred}} = - ( {y}_{target} - {y}_{pred} ) ,$$

where δ_{ypred} represents an error gradient corresponding to y_{pred}. The gradient δ_{ypred} is passed to the previous second linear layer and is used to calculate weight gradient ΔW₂ and activation error gradient δₕ₁ for the second linear layer as follows,

$$Δ {W}_{2} = \frac{\partial L}{\partial {W}_{2}} = {δ}_{{y}_{pred}} {h}_{1}^{T}$$

$${δ}_{{h}_{1}} = \frac{\partial L}{\partial {h}_{1}} = {W}_{2}^{T} {δ}_{{y}_{pred}} .$$

Since the weight gradient ΔW₂ has been calculated in this manner, weights for the second linear layer W₂ can be updated in accordance with stochastic gradient descent (SGD) algorithm as follows,

W₂←W₂−ηΔW₂,

where η is a learning rate which is a hyperparameter.

Then, the error gradient δₕ₁ is passed to the ReLU function layer and is used to calculate an error gradient δ_{z1} as follows,

$${δ}_{{z}_{1}} = \frac{\partial L}{\partial {z}_{1}} = \frac{\partial L}{\partial {h}_{1}} \frac{\partial {h}_{1}}{\partial {z}_{1}} = {δ}_{{h}_{1}} \frac{\partial {h}_{1}}{\partial {z}_{1}} ,$$

where

$$\frac{\partial {h}_{1}}{\partial {z}_{1}}$$

corresponds to the backward gradient of the ReLU function, which is simply set to 1 for all non-zero outputs of the ReLU function during the forward pass and 0 otherwise.

The error gradient δ_{z1} is also an output error gradient for the first linear layer. Thus, a weight and an error gradient for the first linear layer can be calculated as follows,

$$Δ {W}_{1} = \frac{\partial L}{\partial {W}_{1}} = {δ}_{{z}_{1}} {x}^{T}$$

$${δ}_{x} = \frac{\partial L}{\partial x} = {W}_{1}^{T} {δ}_{{y}_{pred}} .$$

Here, δₓ represents an error gradient for the input vector x, and the weight W₁ is updated in accordance with the SGD algorithm as follows,

W₁←W₁−ηΔW₁.

### [Backward Pass Using Fixed Loss Scaling]

Then, an exemplary backward pass in accordance with a fixed loss scaling scheme is described. Here, the backward pass computation as stated above can be modified to support the fixed loss scaling scheme. When the FP16 format is used, fixed gradients could be smaller than the smallest representable FP16 value (uₘᵢₙ) and be truncated to 0. In order to deal with the underflow issue and make the FP16 training work correctly, a fixed loss scale factor α, which may be typically set to an integer larger than 1, is introduced to scale the loss function output L, and the scaled loss value α L is used for the backward pass. Note that since all of the gradient computations are linear, all of the gradients will be also scaled by the same α. As long as a is chosen large enough, the underflow can be prevented.

The scaled loss value is used as follows,

$$α {δ}_{{y}_{pred}} = \frac{\partial α L}{\partial {y}_{pred}} = - α ( {y}_{target} - {y}_{pred} ) .$$

Then, scaled gradients for the second linear layer are computed as follows,

$$scaled ( Δ {W}_{2} ) = α Δ {W}_{2} = \frac{\partial α L}{\partial {W}_{2}} = ( α {δ}_{{y}_{pred}} ) {h}_{1}^{T}$$

$$scaled ( {δ}_{{h}_{1}} ) = α {δ}_{{h}_{1}} = \frac{\partial α L}{\partial {h}_{1}} = {W}_{2}^{T} ( {αδ}_{{y}_{pred}} ) ,$$

where scaled(ΔW₂) represents a weight gradient for W₂ and are equal to αΔW₂.

Also, a scaled gradient for the ReLU function is computed as follows,

$$scaled ( {δ}_{{z}_{1}} ) = \frac{\partial α L}{\partial {z}_{1}} = \frac{\partial α L}{\partial {h}_{1}} \frac{\partial {h}_{1}}{\partial {z}_{1}} = scaled ( {δ}_{{h}_{1}} ) \frac{\partial {h}_{1}}{\partial {z}_{1}} = ( {αδ}_{{h}_{1}} ) \frac{\partial {h}_{1}}{\partial {z}_{1}} .$$

Note that scaled(δ_{z}_{₁})=αδ_{Z}_{₁} and δ_{z1} are not directly computed, because they could be too small to be represented in the FP16.

Then, scaled gradients for the first linear layer are computed as follows,

$$scaled ( Δ {W}_{1} ) = α Δ {W}_{1} = \frac{\partial α L}{\partial {W}_{1}} = scaled ( {δ}_{{z}_{1}} ) {x}^{T}$$

$$scaled ( {δ}_{x} ) = α {δ}_{x} = \frac{\partial α L}{\partial x} = {W}_{1}^{T} ( {αδ}_{{y}_{pred}} ) .$$

As can been observed, all gradients are scaled by the same α.

The actual gradients may be used for the weight updating to be independent of the particular choice of the loss scale factor α. This is easily achieved by simply rescaling the gradients by 1/α before performing the weight updating. The rescaled weight updating become as follows,

W₂←W₂−η(scaled(ΔW₂))/α

W₁←W₁−η(scaled(ΔW₁))/α.

In other words, the weights W₁ and W₂ may be updated as follows,

W₂←W₂−η(αΔW₂)/α

W₁←W₁−η(αΔW₁)/α.

However, the above fixed loss scaling scheme may have some drawbacks. First, the loss scale factor α is a hyperparameter that must be tuned. In practice, a single value of the loss scale factor α will not work well for general neural network models, because either excessive underflow or overflow could occur. The gradient magnitudes are generally different in different layers, and such a single α may not be optimal for all layers.

### [Backward Pass Using Adaptive Loss Scaling]

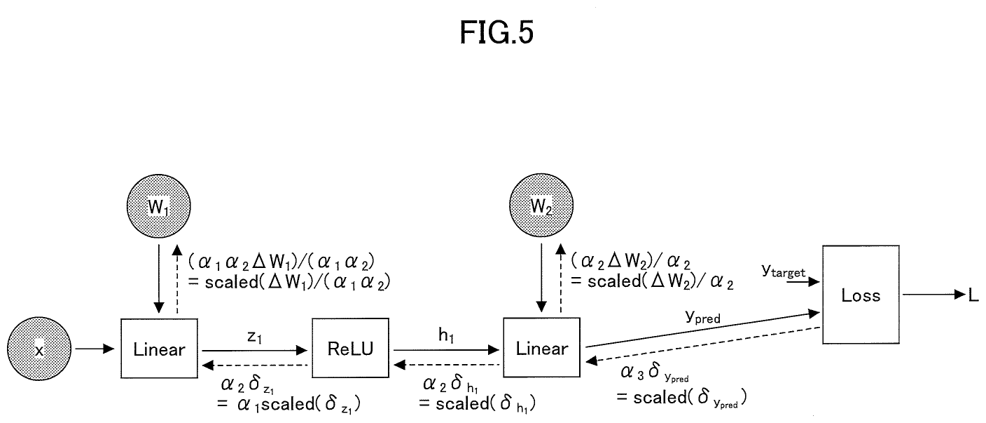

An adaptive loss scaling scheme according to one embodiment of the present disclosure is described with reference to FIG. 5. FIG. 5 is a schematic drawing for illustrating an exemplary training operation based on an adaptive loss scaling scheme according to one embodiment of the present disclosure.

Here, the backward pass computations as stated above can be modified to support the adaptive loss scaling scheme. According to the adaptive loss scaling scheme, the loss scaling factor α does not need to be manually tuned. In place of the single α, layer-wise loss scale factors αᵢ are automatically computed for respective layers i, but not limited to, based on statistics of the weights and gradients.

The layer-wise loss scale factors αᵢ may be computed as follows,

$$scaled ( {δ}_{{y}_{pred}} ) = {α}_{3} {δ}_{{y}_{pred}} = \frac{\partial {α}_{3} L}{\partial {y}_{pred}} = - {α}_{3} ( {y}_{target} - {y}_{pred} ) ,$$

where scaled(δ_{y}_{_{pred}}) represents an error gradient scaled with α₃ for the second linear layer. The error gradient scaled(δ_{y}_{_{pred}}) is passed to the second linear layer and is used to compute the weight gradient Δ W₂,

scaled(ΔW₂)=scaled(δ_{y}_{_{pred}})h₁^{T}.

Normally, the activation error gradient δₕ₁ is computed as follows,

scaled(δₕ_{₁})=W₂^{T}scaled(δ_{y}_{_{pred}}).

The loss scaling factor an for the second linear layer is automatically computed as follows,

scaled(δₕ_{₁})=(α₂W₂)^{T}δ_{y}_{_{pred}}.

Namely, the weight W₂ is scaled by the loss scale factor α₂. The computed scaled gradient will satisfy the following formula,

scaled(δₕ_{₁})=α₂δₕ_{₁}.

Here, α₂δₕ_{₁} is not explicitly computed, and the scaled gradient scaled(δₕ_{₁}) is computed. The computed loss scale factor αᵢ should have at most Tᵤ percentage (i.e., 0.001) of underflow values in the scaled activation gradient scaled(δₕ_{₁}). The value 0.001 works well for all models tested so far.

The loss scale factor αᵢ can be automatically computed based on the statistics of W₂ and δ_{pred}. A Instead of W₂ and δ_{ypred}, the general notations Wᵢ and δᵢ are used respectively. For the i-th linear layer, the gradient computation is given as

scaled(δᵢ₋₁)=(αᵢWᵢ)^{T}δᵢ.

If it is assumed that the gradients and weight values are distributed as i.i.d. Gaussian random variables, the mean and variance of Wᵢ can be computed as follows,

μ_{W}_{ᵢ}←(1/N_{W}_{ᵢ})ΣₙWᵢ(n)

σ_{W}_{ᵢ}²←(1/N_{W}_{ᵢ})Σₙ(Wᵢ(n)−μ_{W}_{ᵢ})²,

where N_{Wi} is the number of values in Wᵢ (if it is very large, a small random sample could instead be used to improve runtime speed). In the same manner, the mean and variance of δᵢ can be obtained. The computational cost is only linear in the number of elements in the weights and gradients.

From these estimated statistics, the variance of δᵢ₋₁ can be computed as follows,

σ_{δ}_{_{i−1}}²←(σ_{W}_{ᵢ}²+μ_{W}_{ᵢ}²)(σ_{δ}_{ᵢ}²+μ_{δ}_{ᵢ}²).

The variance σ_{δ}_{_{i−1}}² can be used to compute the lower bound for the loss scaling factor αᵢ as follows,

$${α}_{i} \geq \frac{{u}_{min}}{{σ}_{{δ}_{i - 1}} \sqrt{2} {erf}^{- 1} ( {T}_{u} )} ,$$

where erf is a Gauss error function defined as

$$erf ( x ) = \frac{1}{\sqrt{π}} {\int }_{- x}^{x} {e}^{{t}^{2}} dt .$$

In the adaptive loss scaling scheme, an introduced interpretable hyperparameter Tᵤ does not need to be tuned to particular models. Specifically, Tᵤ represents the fraction of activation gradient values that are allowed to underflow for each layer. Since uₘᵢₙ=2⁻¹⁴ represents the smallest non-zero value in the FP16, Tᵤ may represent the fraction of activation gradient values that are allowed to be smaller than uₘᵢₙ. Note that uₘᵢₙ is determined in the IEEE FP16 standard and is not a hyperparameter. Tᵤ does not need to be set to exactly 0 but may be instead set to a small value. This is because the distribution of gradients is empirically known to be approximately Gaussian, and it is not practical to eliminate all underflow values. Rather, it is only necessary to eliminate a significant number of underflow values to train the neural networks without accuracy loss.

Also, an upper bound for the loss scale factor αᵢ may be computed such that it does not cause overflow as follows,

αᵢ≤1/(max(Wᵢ)×max(δ_{f})).

Then, the loss scale factor αᵢ for each previous layer can be computed in the same manner. After the loss scale factors αᵢ have been obtained for the first and second layers as illustrated in FIG. 5, the weights W₂ and W₁ are updated as follows,

W₂←W₂−ηscaled(ΔW₂)/α₂

W₁←W₁−ηscaled(ΔW₁)/(α₁α₂).

Also, these formulae may be rewritten as follows,

W₂←W₂−η(α₂ΔW₂)/α₂

W₁←W₁←η(α₁α₂ΔW₁)/(α₁α₂).

In the embodiments as stated above, the layer-wise loss scale factors are computed based on statistical estimates of the weights and gradients. However, there are also other methods that can potentially be used to automatically compute the loss scale factors. As one example, it is possible to automatically compute the loss scale factors without relying on the assumption of Gaussian-distributed weights and gradients and instead use empirical distributions of weights and gradients as follows. Start with a mini-batch of examples and assume that no learning updates (i.e., no weight updates) will be performed until after all layer-wise loss scale factors have been computed for the first time. The forward pass is first computed as normal. Then, a set of possible loss scale factors consisting of all powers of 2 that are representable in the FP16 or some reasonable subset of them is generated. For each of these loss scale factors, it is tentatively chosen, and the backward pass is computed for the last layer N−1 in the network. The set of loss scale candidates can be iterated over in an increasing order starting from 1 as the most naive method. Also, other iteration orders are also possible, such as binary search based on whether the value caused overflow. For the computed scaled input gradients, the histogram of counts of each distinct exponent value in the FP16 exponent field as shown in FIG. 3 is computed. Then, the number of 0 values is saved, and it is noted whether the overflow has occurred. If there is any overflow, the current loss scale factors are discarded from further consideration. After all possible loss scale factors have been iterated, several possible metrics can be used to score the “goodness” of each of the loss scale factors, from which the beast loss scale factor can be chosen for the current layer.

Then, the loss scale goodness metric is computed, and the best loss scale factor is chosen as the one that resulted in the lowest sparsity (that is, the minimum number of zero values) in the computed input gradients without causing the overflow. If multiple loss scale factors are tied, any of them is selected randomly, as the minimum, the mean or the median value of all the tied loss scale factors.

Once the loss scale factor is selected for the current layer, the loss scale factors are computed in the previous layer in the same manner. All remaining steps stay the same as the previous description of adaptive loss scaling.

Since this method can be thought of as a “brute force” method of finding good loss scale factors, it is much more computationally expensive than the alternative method of using statistical estimates in the default method. However, these expensive computations may not need to be computed often in practice, resulting in low overhead. This is because it is reasonable to assume that the weight values change slowly as the neural network is trained, which implies that the best adaptive loss scale factors may also change slowly. As long as this is the case, it may be sufficient to recompute the loss scale factors only every k iterations, where k might be large in practice (e.g., 10, 100, 1000, etc.). Also, when the loss scale factors are recomputed, it can be assumed that the new ideal value may be relatively close to the current value. Accordingly, it may no longer be necessary to search over all loss scale factors, but only over a subset that is close to the current value, which may speed up the computation.

### [Training Apparatus]

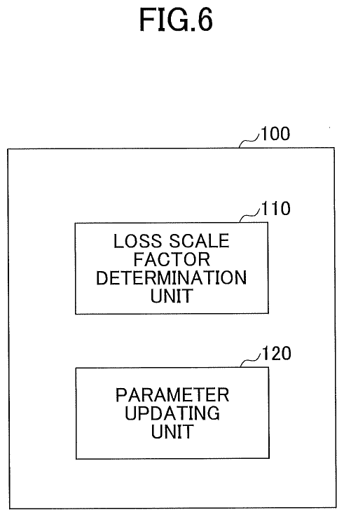

The training apparatus 100 according to one embodiment of the present disclosure is described with reference to FIG. 6. The training apparatus 100 trains neural networks in accordance with the above-stated adaptive loss scaling scheme. The training apparatus 100 supports IEEE half-precision floating point format (FP16). FIG. 6 is a block diagram for illustrating a functional arrangement of the training apparatus 100 according to one embodiment of the present disclosure.

As illustrated in FIG. 6, the training apparatus 100 includes a loss scale factor determination unit 110 and a parameter updating unit 120.

The loss scale factor determination unit 110 determines layer-wise loss scale factors for the respective layers. Specifically, the loss scale factor determination unit 110 determines the layer-wise loss scale factors αᵢ based on statistics of weight values and gradients for the respective layers i (1≤i≤n).

In one embodiment, the loss scale factor determination unit 110 may determine the layer-wise loss scale factors αᵢ to be larger than a lower bound determined based on the statistics, a predetermined value and a Gaussian error function value of a hyperparamater. Specifically, upon obtaining a prediction value y_{pred} in the forward pass of a to-be-trained neural network, the loss scale factor determination unit 110 may use the mean μ_{Wi} and variance σ_{Wi}² of the weight Wᵢ and the mean μ_{δi} and variance σ_{δi}² of the gradient δ₁ for the i-th layer to compute αᵢ in accordance with the lower bound (for example, αᵢ may be the smallest integer satisfying the lower bound) as follows,

$${α}_{i} \geq \frac{{u}_{min}}{{σ}_{{δ}_{i - 1}} \sqrt{2} {erf}^{- 1} ( {T}_{u} )} ,$$

where uₘᵢₙ is a predetermined value (for example, uₘᵢₙ=2⁻¹⁴ for the FP16), σ_{δi-1} is derived based on the obtained statistics for the i-th weight W₁ as follows,

σ_{δ}_{_{i−1}}²←(σ_{W}_{ᵢ}²+μ_{W}_{ᵢ}²)(σ_{δ}_{ᵢ}²+μ_{δ}_{ᵢ}²),

Tᵤ is a hyperparameter and may be set to a fraction of gradient values that are allowed to be smaller than uₘᵢₙ, and erf is a Gauss error function defined as

$$erf ( x ) = \frac{1}{\sqrt{π}} {\int }_{- x}^{x} {e}^{{t}^{2}} dt .$$

As stated above, it seems that Tᵤ=0.001 may empirically work well for any neural network. Also, it is assumed that the weights and the gradients for the respective layers are distributed as i.i.d Gaussian random variables.

In one embodiment, the layer-wise loss scale factors αᵢ may be dynamically updated during training. For example, the loss scale factor determination unit 110 may update the layer-wise loss scale factors αᵢ once for a predetermined number of training data. For example, the loss scale factor determination unit 110 may update the layer-wise loss scale factors ax for each training data.

The parameter updating unit 120 updates parameters for the linear layers in accordance with error gradients for the linear layers, and the error gradients are scaled with the corresponding layer-wise loss scale factors. Specifically, upon obtaining the layer-wise loss scale factor αᵢ for the i-th layer from the loss scale factor determination unit 110, the parameter updating unit 120 updates the weight Wᵢ as follows,

Wᵢ←Wᵢ−η(αᵢ . . . αₙΔWᵢ)/αᵢ.

One particular element-wise operation that requires special treatment is branching. It is used mainly in networks that employ skip connections, such as ResNets. The branching layer in general has one input x and M outputs y₁, y₂, . . . , y_{M}. This layer performs no actual computation during the forward pass, and simply copies its input x to each of its M outputs unchanged, so that y₁=x, y₂=x, . . . , y_{M}=x. Then, during the backward pass, M output gradient vectors arrive at the outputs and are summed by the layer to compute the gradients for its input:

$${δ}_{x} = {\sum }_{m = 1}^{M} \frac{\partial L}{\partial {y}_{m}} .$$

However, when adaptive loss scaling is used, each of the M gradients may potentially have a distinct loss scale value αₘ. It is not possible to sum these scaled gradients directly, since it would destroy the loss scale information and compute an incorrect result. A naive solution would be to first unscale the gradients and then sum them as follows:

$${δ}_{x} = {\sum }_{m = 1}^{M} scaled ( \frac{\partial L}{\partial {y}_{m}} ) / {α}_{m} .$$

Although this will compute the correct result if an enough numerical precision is given, it is likely to cause underflow issues when the FP16 is used because the αₘ values are generally larger than 1 and the division operation will therefore push the partial sum closer to 0, potentially causing the underflow. The underflow can be minimized by rescaling by larger values αₘₐₓ/αₘ, where aₘₐₓ is chosen as the maximum loss scale among the M αₘ values such that overflow does not occur in the following:

$$scaled ( {δ}_{x} ) = {\sum }_{m = 1}^{M} scaled ( \frac{\partial L}{\partial {y}_{m}} ) * ( {α}_{max} / {α}_{m} ) ,$$

where the computed scaled input gradients scaled(δₓ) will then be equal to δₓαₘₐₓ. Since M is small in practice (usually 2), a straightforward algorithm is to first sort the αₘ values in a descending order and tentatively set a αₘₐₓ to be equal to the largest one of them. If it causes underflow at attempting to compute scaled(δₓ), move on to the next smaller αₘ and try again. This requires M iterations at most to find a suitable αₘₐₓ.

### [Training Operation]

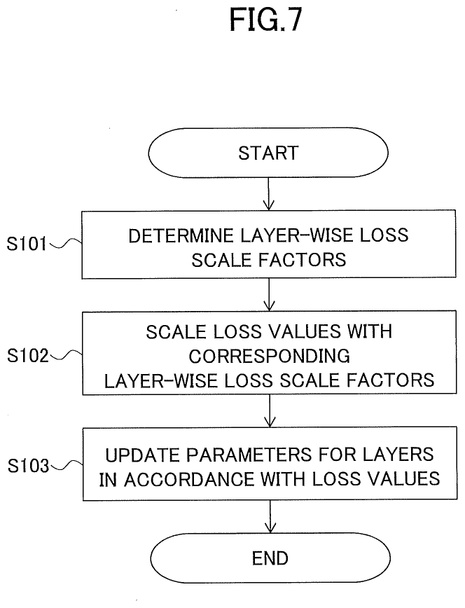

Next, a training operation according to one embodiment of the present disclosure is described with reference to FIG. 7. The training operation may be implemented by the training apparatus 100, particularly by a processor in the training apparatus 100 running one or more programs. FIG. 7 is a flowchart for illustrating the training operation according to one embodiment of the present disclosure.

As illustrated in FIG. 7, at step S101, the training apparatus 100 determines layer-wise loss scale factors αᵢ for respective layers in a to-be-trained neural network. For example, the training apparatus 100 determines the layer-wise loss scale factors αᵢ as an integer satisfying

$$\frac{{u}_{min}}{{σ}_{{δ}_{i - 1}} \sqrt{2} {erf}^{- 1} ( {T}_{u} )} \leq {α}_{i} \leq 1 / ( max ( {W}_{i} ) \times max ( {δ}_{i} ) ) .$$

At step S102, the training apparatus 100 scales loss values L with the corresponding layer-wise loss scale values αᵢ. For example, the loss value L may be derived from the squared-error function.

At step S103, the training apparatus 100 updates parameters for respective layers in accordance with the error gradients. Specifically, the training apparatus 100 may update the weights Wᵢ for the i-th layer as follows,

Wᵢ←Wᵢ−η(αᵢ . . . αₙΔWᵢ)/αᵢ,

where η is a learning rate.

The embodiments as stated above focus on the FP16 as the low-precision alternative to the usual FP32 training, because it is already widely supported in several GPUs. However, in the future other low precision representations such as the FP8 or various other numerical formats could become common. Embodiments making use of various low-precision representations could be compatible with the adaptive loss scaling.

As a runtime performance optimization, the loss scale factor determination unit 110 can be executed every k iterations, where k is a non-negative integer. In the default implementation, k=1, but there is some runtime overhead in computing the adaptive loss scale factors. This runtime overhead can be reduced if the loss scale factor determination unit 110 is only activated every k iterations. For example, if k=10 is used, the runtime overhead of computing the loss scale factors is also reduced by a factor of 10.

As an additional runtime performance optimization, when computing the sample mean and variance statistics of the weights and gradients, a random sparse sample of their respective values may be used to reduce the number of needed computations. That is, N_{W} is effectively reduced to much smaller values, depending on the chosen sparsity.

### [Hardware Arrangement]

The training apparatus 100 according to the above-stated embodiments may be partially or wholly arranged with one or more hardware resources or may be implemented by a CPU (Central Processing Unit), a GPU (Graphics Processing Unit) or others running one or more software items or programs. If the training apparatus 100 is implemented by running the software items, the software items serving as at least a portion of functionalities of the training apparatus 100 according to the above-stated embodiments may be executed by loading the software items, which are stored in a non-transitory storage medium (non-transitory computer-readable medium) such as a flexible disk, a CD-ROM (Compact Disc-Read Only Memory) or a USB (Universal Serial Bus) memory, to a computer. Alternatively, the software items may be downloaded via a communication network. Furthermore, the software items may be implemented with hardware resources by incorporating the software items in one or more processing circuits such as an ASIC (Application Specific Integrated Circuit) or a FPGA (Field Programmable Gate Array).

The present disclosure is not limited to a certain type of storage medium for storing the software items. The storage medium is not limited to a removable one such as a magnetic disk or an optical disk and may be a fixed type of storage medium such as a hard disk or a memory. Also, the storage medium may be provided inside or outside of a computer.

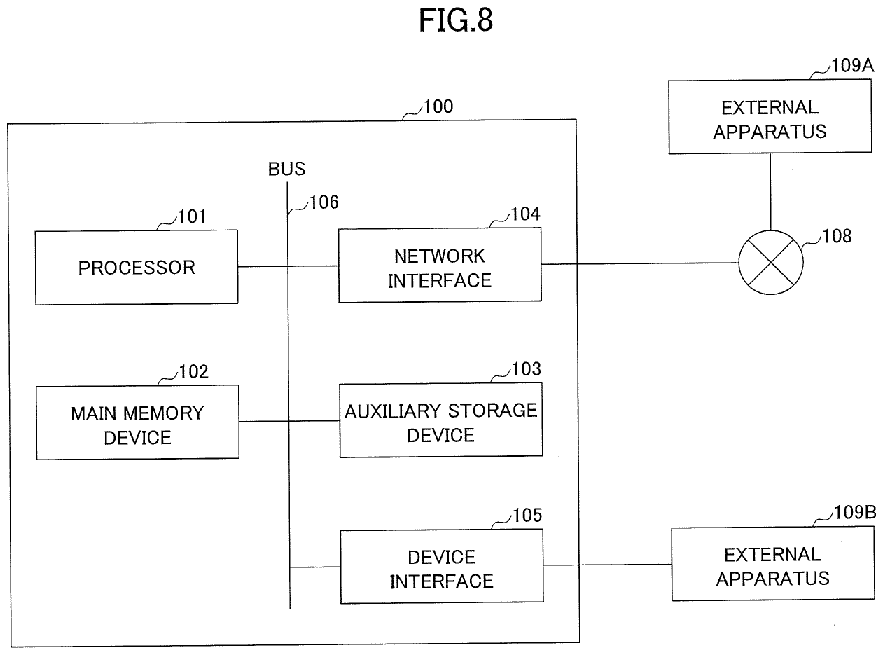

FIG. 8 is a block diagram for illustrating one exemplary hardware arrangement of the training apparatus 100 according to the above-stated embodiments. As one example, the training apparatus 100 may include a processor 101, a main storage device (memory) 102, an auxiliary storage device (memory) 103, a network interface 104 and a device interface 105 and may be implemented as a computer having these devices interconnected via a bus 106.

In FIG. 8, the computer has the respective components singly, but the respective components may be included plurally. Also, the single computer is illustrated in FIG. 8, but software items may be installed in a plurality of computers, each of which may run the same portion or different portions of the software items. In this case, the computers may be implemented with a distributed computing implementation, where the respective computers operate in communication via the network interface 104 or others. In other words, the training apparatus 100 according to the above-stated embodiments may be implemented as a system that achieves the functionalities by the single or plural computers running instructions stored in one or more storage media. Also, the training apparatus 100 may be implemented with the single or plural computers on a cloud network processing information transmitted from a terminal and returning processing results to the terminal.

Various operations of the training apparatus 100 according to the above-stated embodiments may be executed in parallel with use of one or more processors or plural computers via a network. Also, the various operations may be distributed into a plurality of processing cores in a processor and may be executed by the processing cores in parallel. Also, a portion or all of operations, solutions or others of the present disclosure may be performed by at least one of a processor and a storage medium that are provided on a cloud network communicatively coupled to the computer via a network. In this fashion, the training apparatus 100 according to the above-stated embodiments may be implemented in a parallel computing implementation with one or more computers.

The processor 101 may be an electronic circuitry including a control device and an arithmetic device for the computer (for example, a processing circuit, a processing circuitry, a CPU, a GPU, a FPGA, an ASIC or the like). Also, the processor 101 may be a semiconductor device or the like including a dedicated processing circuitry. The processor 101 is not limited to an electronic circuitry using an electronic logic element and may be implemented with an optical circuitry using an optical logic element. Also, the processor 101 may include quantum computing based arithmetic functionalities.

The processor 101 can perform arithmetic operations based on incoming data or software items (programs) provided from respective devices or the like in an internal arrangement of the computer and supply operation results or control signals to the respective devices or the like. The processor 101 may run an OS (Operating System) or an application to control the respective components in the computer.

The training apparatus 100 according to the above-stated embodiments may be implemented with one or more processors 101. Here, the processor 101 may be referred to as one or more electronic circuitries mounted on a single chip or one or more electronic circuitries mounted on two or more chips or two or more devices. If a plurality of electronic circuitries are used, the respective electronic circuitries may communicate with each other a wireless or wired manner.

The main storage device 102 is a storage device for storing various data or instructions executed by the processor 101, and the processor 101 reads information stored in the main storage device 102. The auxiliary storage device 103 is a storage device other than the main storage device 102. Note that these storage devices may mean arbitrary electronic parts capable of storing electronic information and may be semiconductor memories. The semiconductor memory may be any of a volatile memory or a non-volatile memory. The storage device for storing various data in the training apparatus 100 according to the above-stated embodiments may be implemented as the main storage device 102 or the auxiliary storage device 103 and may be implemented as an internal memory incorporated in the processor 101. For example, the loss scale factor determination unit 110 and/or the parameter updating unit 120 may be implemented with the main storage device 102 or the auxiliary storage device 103.

A single processor or plural processors may be connected or coupled to a single storage device (memory). A plurality of storage devices (memories) may be connected or coupled to a single processor. If the training apparatus 100 according to the above-stated embodiments is composed of at least one storage device (memory) and a plurality of processors connected or coupled to the at least one storage device (memory), at least one processor in the plurality pf processors may be connected or coupled to at least one storage device (memory). Also, this arrangement may be implemented with storage devices (memories) and processors in a plurality of computers. Furthermore, the storage device (memory) may be integrated with the processor (for example, a cache memory including an L1 cache and an L2 cache).

The network interface 104 is an interface for connecting with a communication network 108 in a wireless or wired manner. The network interface 104 may be any interface suitable for an existing communication standard or others. Information may be exchanged with an external device 109A connected via a communication network 108 with use of the network interface 104. Note that the communication network 108 may be a WAN (Wide Area Network), a LAN (Local Area Network), a PAN (Personal Area Network) or others or a combination thereof and may be any type of communication network where information can be exchanged between the computer and the external device 109A. One example of the WAN is the Internet. Also, one example of the LAN is an IEEE802.11 or Ethernet. Also, one example of the PAN is Bluetooth, a NFC (Near Field Communication) or the like.

The device interface 105 is an interface for connecting with an external device 109B directly, for example, a USB or the like.

The external device 109A is a device coupled to the computer via a network. The external device 109B is a device directly coupled to the computer.

As one example, the external device 109A or the external device 109B may be an input device. For example, the input device may be a camera, a microphone, a motion capture, various types of sensors, a keyboard, a mouse or a touch panel to provide acquired information to the computer. Also, the external device 109A or 109B may be a device including an input unit, a memory and a processor such as a personal computer, a tablet terminal or a smartphone.

As one example, the external device 109A or 109B may be an output device. For example, the output device may be a display device such as a LCD (Liquid Crystal Display), a CRT (Cathode Ray Tube), a PDP (Plasma Display Panel) or an organic EL (Electro Luminescence) panel or a speaker for outputting sounds. Also, the output device may be any device including an output unit, a memory and a processor such as a personal computer, a tablet terminal or a smartphone.

Also, the external device 109A or 109B may be a storage device (memory). For example, the external device 109A may be a network storage or the like, and the external device 109B may be a storage such as a HDD.

Also, the external device 109A or 109B may be a device including a portion of functionalities of components in the training apparatus 100 according to the above-stated embodiments. In other words, the computer may transmit or receive a portion or all of processing results of the external device 109A or 109B.

If an expression “at least one of a, b and c” or “at least of a, b or c” (including similar expressions) is used in the present specification (including claims), it means that any of a, b, c, a-b, a-c, b-c or a-b-c may be included. Also, it means that multiple instances for any of the elements, such as a-a, a-b-b or a-a-b-b-c-c, may be included. Furthermore, it means that an element other than the enumerated elements (a, b and c), such as d of a-b-c-d, may be included.

If some expressions (including similar expressions) such as “as incoming data”, “based on data”, “in accordance with data” or “depending on data” are used in the present specification (including claims), some cases where various data may be used as inputs and/or where data (for example, noise added data, normalized data, intermediate representations of various data or the like) resulting from some operation on various data may be used as inputs may be included, unless specifically stated otherwise. Also, if it is described that some results are obtained through “as incoming data”, “based on data”, “in accordance with data” or “depending on data”, not only cases where the results are obtained based on only the data but also cases where the results are obtained under other data, factors, conditions and/or states may be included. Also, if “data is output” is described, some cases where various data are used as outputs and/or where data (for example, noise added data, normalized data, intermediate representations of various data or the like) resulting from some operation on various data may be used as outputs may be included, unless specifically stated otherwise.

If terminologies “connected” and “coupled” are used in the present specification (including claims), the terminologies are intended to be interpreted as non-limiting terminologies, including any of direct connection/coupling, indirect connection/coupling, electric connection/coupling, communicative connection/coupling, operative connection/coupling, physical connection/coupling or the like. Although the terminologies should be appropriately interpreted depending on the context of usage of the terminologies, implementations of connection/coupling that should not be excluded intentionally or naturally should be interpreted as be included in the terminologies in a non-limiting manner.

If the expression “A configured to B” is used in the present specification (including claims), a physical structure of the element A may not only have an arrangement that can perform the operation B but also include an implementation where a permanent or temporary setting or configuration of the element A is configured or set to perform the operation B. For example, if the element A is a generic processor, the element A may have a hardware arrangement that enables the operation B to be performed and be configured to perform the operation B in accordance with permanent or temporary programs or instructions. Also, if the element A is a dedicated processor or a dedicated arithmetic circuitry or the like, a circuit structure of the processor may be implemented to perform the operation B regardless of whether control instructions and data are actually attached.

If some terminologies representing inclusion or possession (for example, “comprising” or “including”) are used in the present specification (including claims), these terminologies should be interpreted as open-ended ones, including cases where objects other than the objects indicated by objectives for the terminologies are included or possessed. If these objectives for the terminologies representing inclusion or possession are expressions (expressions to which indefinite article “a” or “an” is attached) that do not specify any amounts or suggest any singular form, the expressions should be interpreted as not being limited to any certain number.

Even if an expression such as “one or more” or “at least one” is used in a passage in the present specification (including claims) and an expression (an expression to which indefinite article “a” or “an” is attached), which does not specify any amounts or suggest any singular form, is used in other passages, it is not intended that the latter expression means “single”. In general, the expression (an expression to which indefinite article “a” or “an” is attached) that does not specify any amounts or suggest any singular form should be interpreted as not being limited to any certain number.

If it is described in the present specification that a specific advantage or result is obtained for a specific arrangement of a certain embodiment, it should be understood that the specific advantage or result can be also obtained for one or more other embodiments having the specific arrangement, unless specifically stated otherwise. It should be understood that presence of the specific advantage or result may generally depend on various factors, conditions and/or states and may not be necessarily obtained under the arrangement. The specific advantage or result may be simply obtained by the specific arrangement disclosed in conjunction with the embodiment under satisfaction of the various factors, conditions and/or states and may not be necessarily obtained by the claimed invention defining the arrangement or similar arrangements.

If some terminologies such as “maximize” are used in the present specification (including claims), the terminologies include determination of a global maximum value, an approximate value of the global maximum value, a local maximum value and an approximate value of the local maximum value and should be appropriately interpreted in the context of usage of the terminologies. Also, the terminologies may include probabilistic or heuristic determination of an approximate value of these maximum values. Analogously, if some terminologies such as “minimize” are used, the terminologies include determination of a global minimum value, an approximate value of the global minimum value, a local minimum value and an approximate value of the local minimum value and should be appropriately interpreted in the context of usage of the terminologies. Also, the terminologies may include probabilistic or heuristic determination of an approximate value of these minimum values. Analogously, if some terminologies such as “optimize” are used, the terminologies include determination of a global optimal value, an approximate value of the global optimal value, a local optimal value and an approximate value of the local optimal value and should be appropriately interpreted in the context of usage of the terminologies. Also, the terminologies may include probabilistic or heuristic determination of an approximate value of these optimal values.

If a plurality of hardware resources perform predetermined operations in the present specification (including claims), the respective hardware resources may perform the operations in cooperation, or a portion of the hardware resources may perform all the operations. Also, some of the hardware resources may perform a portion of the operations, and others may perform the remaining portion of the operations. If some expressions such as “one or more hardware resources perform a first operation, and the one or more hardware resources perform a second operation” are used in the present specification (including claims), the hardware resources responsible for the first operation may be the same or different from the hardware resources responsible for the second operation. In other words, the hardware resources responsible for the first operation and the hardware resources responsible for the second operation may be included in the one or more hardware resources. Note that the hardware resources may include an electronic circuit, a device including the electronic circuit or the like.

If a plurality of storage devices (memories) store data in the present specification (including claims), respective ones of the plurality of storage devices (memories) may store only a portion of the data or the whole data.

Although specific embodiments of the present disclosure have been described in detail, the present disclosure is not limited to the above-stated individual embodiments. Various addition, modification, replacement and partial deletion can be made without deviating the scope of conceptual idea and spirit of the present invention derived from what is defined in claims and its equivalents. For example, if all of the above-stated embodiments are described with reference to some numerical values or formulae, the numerical values or formulae are simply illustrative, and the present disclosure is not limited to the above. Also, the order of operations in the embodiments is simply illustrative, and the present disclosure is not limited to the above.

What is claimed is:

1. A method of training a neural network including a plurality of layers, comprising:
determining, by one or more processors, layer-wise loss scale factors for the respective layers; and
updating, by the one or more processors, parameters for the layers in accordance with error gradients for the layers, wherein the error gradients are scaled with the corresponding layer-wise loss scale factors.

2. The method as claimed in claim 1, wherein the one or more processors support IEEE half-precision floating point format (FP16).

3. The method as claimed in claim 1, wherein the layer-wise loss scale factors are dynamically updated during training.

4. The method as claimed in claim 1, wherein the determining comprises determining the layer-wise loss scale factors based on statistics of weight values and error gradients for the layers.

5. The method as claimed in claim 4, wherein the determining comprises determining the layer-wise loss scale factors to be larger than a lower bound, and the lower bound is determined based on the statistics, a predetermined value and a Gaussian error function value of a hyperparamater.

6. A training apparatus, comprising:
one or more memories that store a neural network including a plurality of layers; and
one or more processors configured to:
determine layer-wise loss scale factors for the respective layers; and
update parameters for the layers in accordance with error gradients for the layers, wherein the error gradients are scaled with the corresponding layer-wise loss scale factors.

7. The training apparatus as claimed in claim 6, wherein the one or more processors support IEEE half-precision floating point format (FP16).

8. The training apparatus as claimed in claim 6, wherein the layer-wise loss scale factors are dynamically updated during training.

9. The training apparatus as claimed in claim 6, wherein the layer-wise loss scale factors are determined based on statistics of weight values and error gradients for the layers.

10. The training apparatus as claimed in claim 9, wherein the layer-wise loss scale factors are determined to be larger than a lower bound, and the lower bound is determined based on the statistics, a predetermined value and a Gaussian error function value of a hyperparamater.

11. A method of generating a trained neural network including a plurality of layers, comprising:
determining, by one or more processors, layer-wise loss scale factors for the respective layers; and
updating, by the one or more processors, parameters for the layers in accordance with error gradients for the layers, wherein the error gradients are scaled with the corresponding layer-wise loss scale factors.

12. The method as claimed in claim 11, wherein the one or more processors support IEEE half-precision floating point format (FP16).

13. The method as claimed in claim 11, wherein the layer-wise loss scale factors are dynamically updated during training.

14. The method as claimed in claim 11, wherein the determining comprises determining the layer-wise loss scale factors based on statistics of weight values and error gradients for the layers.

15. The method as claimed in claim 14, wherein the determining comprises determining the layer-wise loss scale factors to be larger than a lower bound, and the lower bound is determined based on the statistics, a predetermined value and a Gaussian error function value of a hyperparamater.

16. A storage medium for storing a program for causing a computer to:
determine layer-wise loss scale factors for respective layers in a neural network; and
update parameters for the layers in accordance with error gradients for the layers, wherein the error gradients are scaled with the corresponding layer-wise loss scale factors.

17. The storage medium as claimed in claim 16, wherein the one or more processors support IEEE half-precision floating point format (FP16).

18. The storage medium as claimed in claim 16, wherein the layer-wise loss scale factors are dynamically updated during training.

19. The storage medium as claimed in claim 16, wherein the layer-wise loss scale factors are determined based on statistics of weight values and error gradients for the layers.

20. The storage medium as claimed in claim 19, wherein layer-wise loss scale factors are determined to be larger than a lower bound, and the lower bound is determined based on the statistics, a predetermined value and a Gaussian error function value of a hyperparamater.
